(19) United States
(12) Patent Application Publication
(10) Pub. No.: US 2012/0284172 A1
(43) Pub. Date: Nov. 8, 2012

(54) Multi-retailer Lending Using Prepaid Cards/Certificates

(75) Inventor: Evan L. BRYMAN, Portland, OR (US)

(73) Assignee: GENESIS FINANCIAL SOLUTIONS, INC., Beaverton, OR (US)

(21) Appl. No.: 13/099,650

(22) Filed: May 3, 2011

(51) Int. Cl. G06Q 40/00

(52) U.S. Cl. 705/38

(57) ABSTRACT

This disclosure relates to receiving, through a user interface, a selected plurality of retailers and respective requested value amounts, where the selected retailers and value amounts represent a consumer's request for multiple gift cards, and where the gift cards provide purchasing power at the plurality of retailers in the respective value amounts; applying, through a rules engine, a set of rules to the selected retailers and value amounts, where the rules engine is capable of using the rules to determine costs associated with the requested gift cards; generating a financing request for financing for the consumer, where the financing request is based on the selected retailers, the value amounts, and the rules; obtaining, through a loan system interface, financing for the consumer based on the financing request; and using the obtained financing to request the gift cards for the consumer.

### FIELD OF THE DISCLOSURE

This disclosure relates to financing systems for providing consumer loans for purchasing gift cards.

### BACKGROUND

Gift cards are restricted monetary equivalents that are issued by establishments such as retailers or banks, and are popular alternatives to non-monetary gifts. Gift cards are cash equivalents that often resemble credit cards. Unlike credit cards, however, gift cards are generally pre-paid, and are not necessarily linked to a particular individual. Some gift cards can be reloaded by payment and used multiple times, while others are disposed of as soon as the card is redeemed. Gift cards can also be divided into “open loop” and “closed loop” cards. The former are usually issued by banks or credit card companies, and can be redeemed by consumers at different establishments. The latter are usually issued by a specific store or restaurant, and can be redeemed only at that issuer's establishment.

In addition to using cash, consumers may also purchase gift cards on credit, such as by paying for the gift card with a credit card. However, because the credit-card issuer is independent of the retailer that issues the gift card, the consumer may miss out on credit pricing benefits that the retailer would otherwise be willing to provide because of the retailer's knowledge that the money must be spent at the retailer. Conversely, some retailers may provide loans in the form of gift cards, but these retail loans typically can be used at only one store—the store providing the loan. In this case, the consumer can miss out on an ability to leverage their credit to make purchases at other stores.

### Overview

Embodiments are described for providing a consumer loan (or credit line increase) that enables a consumer to purchase at multiple retailers using multiple purchasing vehicles that are each restricted to an individual retailer. For example, systems and methods are provided to enable consumers to seek loans exclusively for purchasing gift cards. The purchase can be for multiple cards, each representing credit at a respective single retailer. The purchase can also be made for gift cards that each contain multiple value amounts, each amount for a respective retailer, or for cards with a single value amount that is good at more than one retailer, or even some mix of these different types of cards.

In some embodiments, gift card financing systems feature intelligent marketing to consumers of specific retailers to promote the sales of individual retailers. This may entail limiting the proportion of a loan that can be used on a specific retailer or group of retailers, ranking and/or recommending specific retailers, discounts/deals for specific retailers, exclusivity in a category for specific retailers, and bundling recommended or required packages of retailers, potentially coupled with incentives for choosing the bundle.

Some embodiments include systems and methods for loan decisioning (e.g., approval decisions, credit line decisions, and price decisions) for financing gift cards. This decisioning may be rules-driven, including rules that determine desired loan terms based on discounts received from retailers between the cost to the lender of providing the gift cards and the face values of the cards.

By enabling loans to be provided in the form of multi-retailer gift cards and/or packages of single-retailer cards, consumers, retailers and financing companies can all benefit. Consumers gain purchasing power, via the loan, that can be used at multiple retailers. Consumers gain also access to a loan that may have more favorable terms than a loan they could have gotten through other channels. Retailers can market and promote themselves to new customers with the assurance of sales provided by a prepaid vehicle. Retailers can also make sales to consumers who otherwise may not have qualified for a loan. By providing a loan to purchase gift cards from multiple stores, a consumer shopping need can be met that is not met by typical individual retailer loans. By meeting a consumer need, marketing can be performed that generates incremental customers for a retailer. By generating incremental customers for a retailer, funding can be obtained that allows for favorable loan approval rates and favorable loan terms. By providing favorable loan terms, consumers gain a benefit that further feeds this cycle of consumer benefit and retailer benefit and financing company benefit.

In a first set of embodiments, a method comprises receiving, through a user interface, a selected plurality of retailers and respective requested value amounts, where the selected retailers and value amounts represent a consumer's request for multiple gift cards, and where the gift cards provide purchasing power at the plurality of retailers in the respective value amounts, and where the gift cards are restricted to purchases from the plurality of retailers; applying, through a rules engine, a set of rules to the selected retailers and value amounts, where the rules engine is capable of using the rules to determine costs associated with the requested gift cards; generating a financing request for financing for the consumer, where the financing request is based on the selected retailers, the value amounts, and the rules; obtaining, through a loan system interface, financing for the consumer based on the financing request; and using the obtained financing to request the gift cards for the consumer.

In certain of this first set embodiments, the costs associated with purchasing the gift cards can depend on which groups of retailers are selected. In other such embodiments, the rules are capable of indicating at least one of: limits to the proportion of a loan that may be used on a specific retailer or group of retailers, a ranking of specific retailers, discounts associated with specific retailers, exclusivity in a category for specific retailers, recommended combinations of retailers, and incentives for choosing recommended combinations. Still other such embodiments further comprise using the rules to promote the sales of individual retailers; receiving a first retailer selection and first respective requested values; applying the rules to the selected first retailer selection and first respective requested values; proposing, based on the rules, a suggested retailer selection or suggested respective values, where the suggested retailer selection or suggested respective values are different from the first retailer selection and first respective requested values. In yet other embodiments, the terms of the obtained financing are further based on the selected retailers, the respective value amounts, and the rules; the financing includes a credit line increase to an existing loan; and/or each of the gift cards can be one of a prepaid stored-value card, an e-gift card, and a gift certificate.

A second set of embodiments include logic encoded in one or more non-transient media that includes code for execution, and when executed by a processor is operable to perform operations comprising any one or more of the above-described embodiments.

A third set of embodiments comprise an order system interface; a loan system interface; a rules engine; a memory capable of storing data; and a processor operable to communicate with the order system interface, loan system interface, and memory, the processor configured for: receiving, through the order system interface, a selected plurality of retailers and respective requested value amounts, where the selected retailers and respective value amounts represent a consumer request for multiple gift cards, where the gift cards provide purchasing power at the plurality of retailers in the respective value amounts, and where the gift cards are restricted to purchases from the plurality of retailers; applying, through the rules engine, a set of rules to the selected retailers and respective value amounts, where the rules engine is capable of using the rules to determine costs associated with purchasing gift cards for the selected retailers in the respective value amounts; determining a request for financing for the consumer, where the request for financing is based on the selected retailers, the respective value amounts, and the rules; obtaining, through the loan system interface, financing for the consumer based on the request for financing; and using the obtained financing to request the gift cards for the consumer.

In this third set of embodiments, the costs associated with purchasing the gift cards can depend on which groups of retailers are selected. In other such embodiments, the rules are capable of indicating at least one of: limits to the proportion of a loan that may be used on a specific retailer or group of retailers, a ranking of specific retailers, discounts associated with specific retailers, exclusivity in a category for specific retailers, recommended combinations of retailers, and incentives for choosing recommended combinations. Still other such embodiments further comprise using the rules to promote the sales of individual retailers; receiving a first retailer selection and first respective requested values; applying the rules to the selected first retailer selection and first respective requested values; proposing, based on the rules, a suggested retailer selection or suggested respective values, where the suggested retailer selection or suggested respective values are different from the first retailer selection and first respective requested values. In yet other embodiments, the terms of the obtained financing are further based on the selected retailers, the respective value amounts, and the rules; the financing includes a credit line increase to an existing loan; and/or each of the gift cards can be one of a prepaid stored-value card, an e-gift card, and a gift certificate.

### BRIEF DESCRIPTION OF THE DRAWINGS

FIG. 1 illustrates an architecture for a consumer loan system in accordance with some embodiments.

FIG. 2 illustrates a flowchart for an order rules engine for in accordance with some embodiments.

FIG. 3 illustrates a flowchart for a promotion rules engine in accordance with some embodiments.

FIG. 4 illustrates a flowchart for a gift-card-based loan rule engine in accordance with some embodiments.

FIG. 5 illustrates a system for making a consumer loan application in accordance with some embodiments.

FIG. 6 illustrates a system for gift card fulfillment in accordance with some embodiments.

### DESCRIPTION OF EXAMPLE EMBODIMENTS

### Loan System

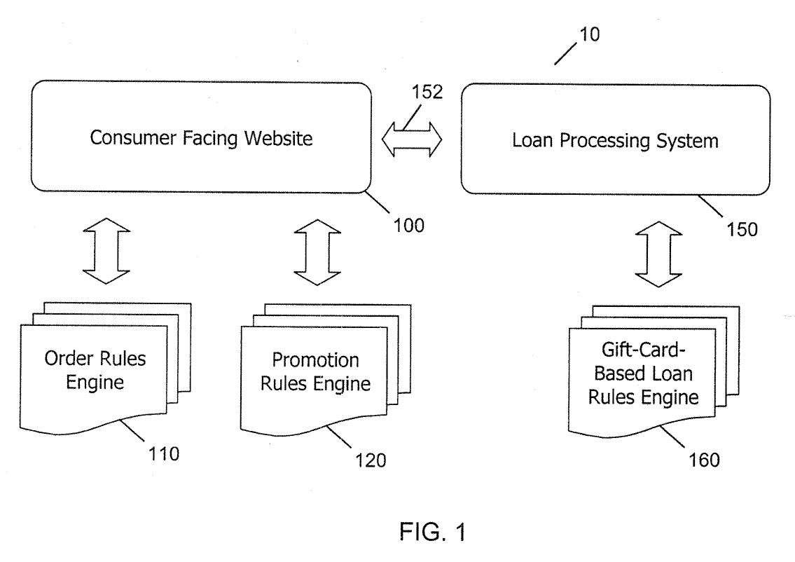

FIG. 1 illustrates a consumer loan system 10 in which a consumer-facing website 100 interacts with a backend loan processing system 150. Website 100 presents an interface to consumers through which they can apply for a loan to purchase gift cards for use with multiple retailer brands. The website 100 works in conjunction with an order rules engine 110 and promotion rules engine 120. The order rules engine 110 determines the types of order a consumer can validly place with the loan system. Promotion rules engine 120 determines if an order qualifies as a promotion order, for which special discounts or other incentives may be provided to the consumer. The promotion rules may also configure the manner in which retailer information is presented to the consumer, such as for purposes of promoting certain retailers. The consumer facing website 100 works in conjunction with the loan processing system 150, which can implement functions such as loan underwriting and servicing. Loan processing system 150 works in conjunction with gift-card-based loan rules engine 160.

Consumer-facing website 100 and backend loan processing system 150 can communicate via loan system interface 152. Both website 100 and loan processing system 150 may also communicate with other components, and may comprise part of a larger system (not shown), including gift card providers and fulfillment systems, other consumer websites, supporting backend systems, and databases. The connections between these systems may be real-time or batched, or a combination of both. Programmatic interfaces are used to support communication between the various component systems that comprise the loan system. Examples of such interfaces include message-based interfaces, shared memory interfaces, and application programming interfaces (APIs).

In some embodiments, website 100 uses a single monolithic computing platform that provides both a graphical user interface (“GUI”) to consumers as well as non-consumer-facing backend processing. In other embodiments, website 100 is implemented on multiple platforms. In such embodiments, one portion of website 100 comprises a platform used to present the GUI to the user through a web-based interface. A second portion of website 100 works in conjunction with the GUI platform to provide backend, non-GUI-oriented, processing. In such embodiments, the backend processing platform uses a programmatic order system interface to communicate with the GUI and the consumer.

In some embodiments, interaction with a consumer could be performed offline, not using a website. Examples include an offer by direct mail where a consumer would check boxes for gift cards that he/she wishes to select. In such cases, all or part of system 10 may be used to enter consumer's orders once they are sent back to a processing center.

### Gift Cards

The gift cards provided in the disclosed embodiments can include prepaid stored-value cards, e-gift cards, or gift certificates, and may be either physical cards or electronic representations of such cards. The gift cards can be directed at brick and mortar retail brands or other website retailers, as well as non-retail vendors, including providers of services. Each gift card can be directed at either multiple brands or a single brand. In some transactions, a consumer may be provided with multiple cards, each directed at one respective brand, where the entire value represented by the set of cards together is financed by the consumer's loan transaction.

### Loans

The loans provided by system 10 can be closed-ended in the sense that there is a fixed term for repayment after which the loan account is closed. Or the loans provided can be open-ended in the sense that the customer may use the credit line to make purchases at any time that there is available credit line for making a purchase. Alternatively, the loan provided may be in the form of extending additional credit on a pre-existing loan, where the additional credit is provided for the purpose of purchasing gift cards. Alternatively, the system may be used to authorize a transaction on a pre-existing line of credit where the authorization system includes the use of gift cards to make a different decision on the authorization request than would have been made if no gift cards were requested to be purchased. The loans provided could also be used for the purchase of goods other than gift cards, if gift cards are required by a rules engine to comprise at least a portion of the purchase. The loans could be used by a consumer or by a business for the purchase of gift cards.

### Loan Approval

The approval of the loan could happen before or after the consumer has selected specific gift cards. If a loan is pre-approved, or a credit line is opened before the consumer selects gift cards then the consumer may have restrictions placed on the purchases that may be made consistent with the rules engine.

### Down Payment

Loan system 10 can provide financing for cards that are to be issued immediately, or for cards that are to be issued in the future after a down payment has been made. These consumers may be rewarded by providing them with gift cards for an amount greater than the initial payment, or down payment, with the consumer then paying off the remainder of the amount after receiving the gift cards.

### Order Rules Engine

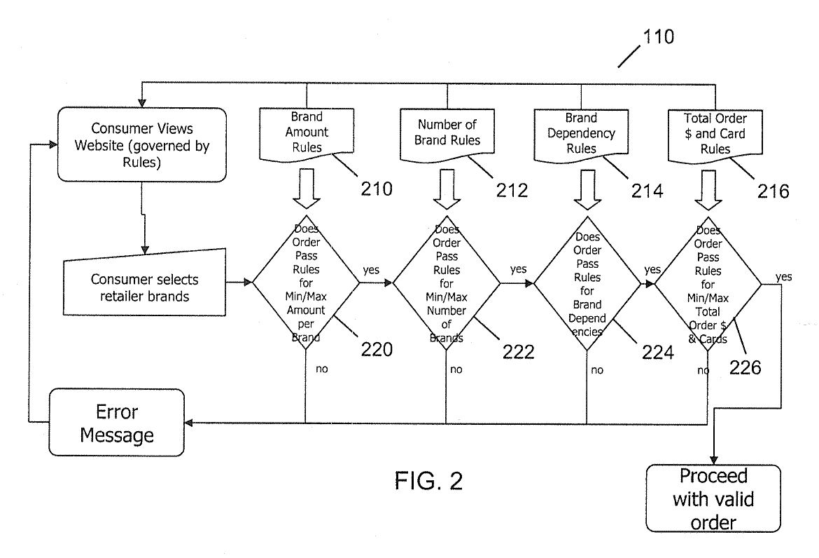

FIG. 2 illustrates a flowchart for order rules engine 110. The order rules engine works by applying various rules to the consumer's selection of gift cards and associated value amounts to determine whether the order is valid. The order rules engine can help control the types and values of gift cards a consumer may purchase. The rules can include rules that are not specific to any particular retailer brand, such as the total number of gift cards a consumer may order, as well as brand-specific “brand rules” that provide rules that are relevant to only certain retailers. Certain brand rules may also specify how different brands are to be presented to consumers through a user interface, as described later in this specification.

The rules can be used within the rules engine to limit both the number and mix of the brands (e.g., retailers) for which a card contains value, as well as the total number of cards purchased. They may also control the distribution of the total value between brands, as well as the minimum and maximum total value amounts for each card and for the total value amount of all the cards combined. Examples of such rules include:

Minimum number of cards=2; Maximum number of cards=5

Minimum total order=$250; Maximum total order=$1000

Minimum order=$500 for retailer “Home Lumber Mart”

Maximum order=$100 for retailer “StarCrossed Coffee”

Cannot order cards for both “ComputerLand” and its subsidiary “ComputerFixers”

In addition to indicating limitations and restrictions, the rules may also indicate the compensation received from retailers, or wholesalers, for selling the gift card. The compensation may be in the form of an advertising or marketing payment, a discount that represents a difference between the cost of the gift cards to the loan system's operator and the face values of the cards, or other payment structure. Different retailers or wholesalers may compensate at different levels and with different structures. Because of this, different mixes of card selections can result in different costs to the loan system operator to obtain loans on behalf of the consumer. These costs may differ even for two orders for the same total requested gift card amount, but with different mixes of retailers. Also, there may be rules representing contractual obligations to retailers or wholesalers that would be known by the loan system's operator. These may be in the form of minimum volumes, approval rates, advertising structures or other agreements that benefit a retailer.

Cost-oriented brand rules help retailers to promote their brands and differentiate their gift-card offerings. Using the cost rules, the loan system can pass along to the consumer some or all of the cost savings associated with a particular retailer's gift card. This may be accomplished by providing the consumer with a lower interest rate loan, or other loan terms that are better than what the consumer could otherwise have obtained without the retailer's discount. A consumer ordering $1000 worth of gift cards might also receive a 5% discount, such that the consumer's total loan is for $950 instead of $1000, with the difference made up for by some or all of the compensation from the retailer. Alternatively, consumers with marginal credit ratings may be able to obtain a loan through the system despite their credit rating by using all or part of the discount to subsidize the loan's relatively higher risk. Or a consumer may be given a more favorable interest rate that they otherwise would be able to obtain. Alternatively, a consumer may receive a coupon or other value added product/service when taking out the loan. More generally, cost-oriented brand rules can also help the order rules engine determine if a certain gift card order request is an economically viable order for the loan system to accept.

In embodiments where the order rules engine is used for order validation such as in FIG. 2, a consumer selects retailer brands and associated value amounts for each brand using the consumer-facing website 100. The order rules engine then applies one or more sets of brand rules (e.g., brand amount rules 210, number of brand rules 212, and brand dependency rules 214), and/or total order amount and card rules 216 to the consumer's selection through respective rule validation checks (e.g., 220, 222, 224, and 226). If any validation check fails, an appropriate error message is provided to the consumer. If the consumer's selection passes all of the asserted rule validation checks, the order is validated.

Brand amount rules 210 include rules on the minimum or maximum amount of gift cards for a particular retailer. Number of brand rules 212 include limitations on how many different retailers a consumer may select gift cards for. Brand dependency rules 214 include limitations on which combinations of retailers a consumer may select in their gift card purchase, and minimum or allowed increments in selected value for cards (e.g., cannot select a total amount that is less than $100, or is not a multiple of $50 for a particular brand). Total order amount and card rules 216 includes limitations on the total value amount for a consumer's gift card selection, such as the minimum or maximum total amount, or minimum increments in selected value for any card, as well as limitations on the minimum or maximum total number of gift cards.

The rules used within the order rules engine may be fixed, or may change dynamically in time, including changes that are based on ongoing commercial relationships with retailers and financial institutions. The rules may be implemented through linear programming techniques within the engine's rule validation checks 220, 222, 224, and 226, or as stored relationships between fixed limits and gift card and brand properties. In the latter case, the rule validation checks 220, 222, 224, and 226 compare each stored relationship (such as “per-brand-value-property<=$500”) to each gift card request on a property-by-property basis. Some or all of the rules used by the order rules engine may also be used by the promotion rules engine and loan engine, described below.

### Promotion Rules Engine

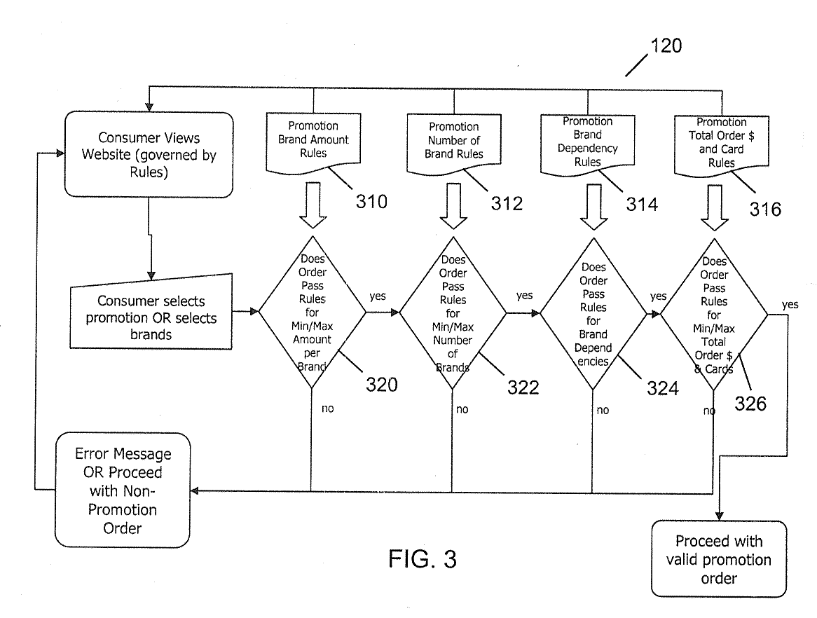

FIG. 3 illustrates a flowchart for a promotion rules engine 120. Promotion rules engine 120 helps determine whether a gift card order qualifies as a promotion order. Promotion orders may be eligible for incentives and special pricing for the consumer. For example, a retailer may agree with the lender to provide a larger-than-usual discount for the retailer's cards if the consumer selects the retailer's card with an amount above some certain value, or selects the gift card along with gift cards from certain other retailers. Users of the loan system may either explicitly opt-in to a particular promotion (such as “Select a $100 or larger gift card from any three retailers in our preferred retailer list and receive a $20 coffee-shop gift card for free!”, or a consumer may be given a more favorable interest rate than they otherwise would be able to obtain, or a consumer may receive a coupon or other value added product/service when taking out the loan), or the user may happen to select a gift-card order that qualifies as a promotion without doing so on purpose. In the former case, the promotion rules engine may be used to validate that the consumer's gift-card order meets the requirements of the promotion. In the latter case, the engine may identify the order as a qualifying promotion order, and then use this information to allow better terms for the loan than the consumer would have received if they had made a different choice.

In embodiments where the promotion rules engine is used to identify and/or validate promotion orders, such as in FIG. 3, a consumer selects retailer brands and associated value amounts for each brand and, optionally, selects a specific promotion. The order rules engine then applies one or more sets of brand rules (e.g., brand amount rules 310, number of brand rules 312, and brand dependency rules 314), and/or total order amount and card rules 316 to the consumer's selection through respective rule validation checks (e.g., 320, 322, 324, and 326). These rules may be similar to or the same as rules 210, 212, 214, and 216, discussed above, but in this case, the limitations embodied in these rules are applied to determining whether a gift card order qualifies as a promotion order instead of simply whether the order is valid. If the consumer's selection passes all of the asserted rule validation checks, the order is validated as a promotion. If any validation check fails, the system can either elect to continue processing the order as a non-promotional order, or reject the order entirely and issue an appropriate error message to the consumer.

### Loan Rules Engine

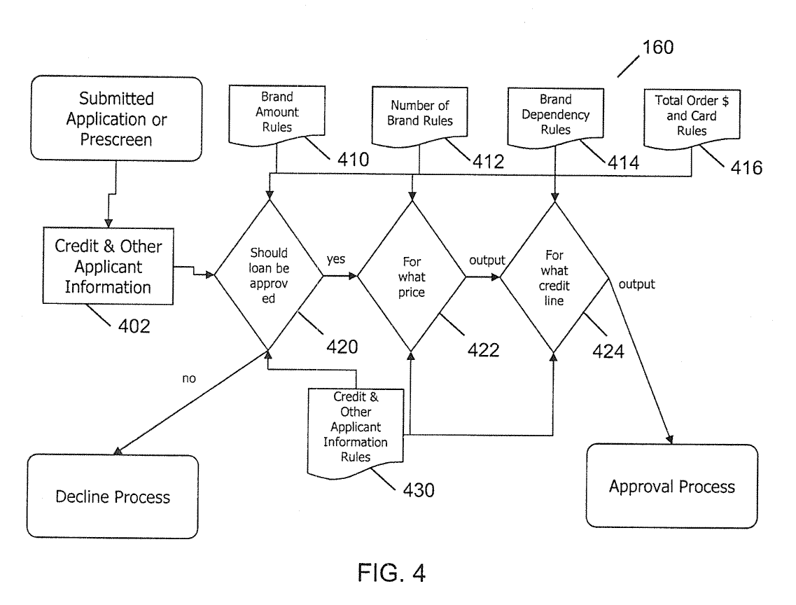

FIG. 4 illustrates a flowchart for a loan rules engine 160. The loan rules engine may be used both for making the decision to approve or deny a loan request, and also for determining the terms of any eventual loan. In some embodiments of the loan system 10, website 100 can advertise a certain “prime” APR loan rate for consumers who have certain qualifying minimum credit credentials. For such consumers, the loan rules engine may need only to ensure that the candidate meets the required credentials in order to select loan terms. In other embodiments, the website may provide a “best” rate and terms, and the loan rules engine will calculate a higher rate, or less beneficial terms, depending on an evaluation of the consumer's credit credentials and the particular gift card order requested.

In some cases, the loan terms may also depend on the price the operator of loan system 10 must pay for the gift cards that will be sold to consumers. Certain gift cards may be available to the operator at a discount on their face value. The brand rules that the loan rules engine applies to an order can store or otherwise allow a calculation of this discount information. The loan rules engine can then calculate loan rates and terms using knowledge of the discounts. For example, the loan rules engine may allow for more favorable credit terms (and a loan with a resulting higher effective cost to the system's operator) if the discount on face value is high enough to mitigate the credit risk or other costs associated with the loan. The discounts provided by retailers can vary with the amounts of the gift cards and with any ongoing promotions. The brand rules can also allow for dynamic discount structures for a particular retailer, where the discounts provided by the retailer are tied to the particular mix of other brands with which the consumer purchases the that retailer's gift card, and/or to information on whether sales targets across multiple loans meet some sales target.

In FIG. 4, credit information and other applicant information 402 is determined from a loan application submitted by a consumer from website 100. The information may also be augmented with information from other consumer credit databases and systems. The submitted application may be for an actual loan, or may have been submitted as part of a pre-screening process. In either case, the loan rules engine then applies to this loan information one or more sets of rules (e.g., brand amount rules 410, number of brand rules 412, and brand dependency rules 414), and/or total loan amount and card rules 416) through respective rule processors (e.g., 420, 422, and 424). These rules may be similar to or the same as rules 210, 212, 214, and 216, discussed above, but in this case, the limitations embodied in these rules are applied to determining whether a loan may be obtained for the requested gift card order, and what the terms of that loan will be. Additional credit rules and other applicant information rules 430 may be applied to and used in any of the rule processors 420, 422, and 424. For example, the additional credit and applicant information rules 430 may represent risk-assessment rules and other loan decisioning rules and information. Rule processor 420 determines whether it will be possible to approve the loan for any available sets of terms and conditions, and declines the loan if not. If the loan in not declined, rule processor 422 determines a price for the loan, and rule process 424 determines the final credit line that will be extended to the consumer in the form of a gift cards. As noted above, the final loan price and credit line determined by the processors may ultimately be based on the brand rules 410, 412, and 414, the credit rules and other applicant information rules 430, as well as the retailers, and the value amounts selected by the consumer.

Separate sets of brand amount rules, number of brand rules, brand dependency rules, and/or total order amount and card rules may be applied respectively in each rules engine, or some or all of the rules may be shared between the engines.

### Rules-Based Consumer Interface

In addition to validating orders, identifying and validating promotions, and determining loan terms, the various rules described above may also be used by the consumer facing website 100 to control how the website's interface is presented and which selections are presented to the consumer. For example, the rules may specify that certain promotional brands may be more prominently displayed than others, such as by graphically emphasizing the promoted brands or by presenting the promoted brands first in display lists. Certain brand selections (such as direct competitors) may be disabled or not presented depending on which brands have already been selected. Possible dollar ranges for the gift cards may also be limited based on criteria such as the consumer's current brand selection in the website's interface. The rules may provide for discount amounts based on criteria such as the total gift card loan amount, the amount allocated to a particular brand or brands, and/or on the selected brand mix. These discounts, or amounts based on them, may be displayed to the user through website 100 in order to notify the consumer of possible savings if the consumer makes certain additional or alternative selections.

Brands may be categorized internally by the web server 100 into brand groups, and the brand-related rules can then based on the mix of the brand groups that constitute a consumer's application for a financed gift card. For example, if retailers are grouped into large, general-purpose retailers and a small specialty shops, consumers may be prompted to choose at least one brand from each group in order to receive a special promotional incentive.

### Promotional Incentives

Incentives for consumers may be triggered by the consumer's decision to choose a promotional gift-card configuration. Promotions can include cards that have certain mixes of brands, minimum per-brand or total value amounts, or cards with particular terms of use, such as cards that must be redeemed relatively quickly. Possible incentives for participating in such promotions include more favorable loan terms, additional value amounts added to the cards, or additional bonus gift cards, or a consumer may receive a coupon or other value added product/service when taking out the loan. For example, a consumer might receive a gift card for a hardware store for selecting a promotion involving furniture and home-decorating retailers, or a coupon for 10% off a retailer of the consumer's choice.

Incentives can be provided for reasons that are not directly associated with the consumer's immediate selection of promoted brand mixes or amounts. For example, incentives for prompt, consistent payback of an earlier gift-card loan may be provided if the same consumer returns to the site later to apply for a loan for additional gift cards. Shipping and handling may be waived or discounted if the customer signs up for automatic payments or for a down payment.

For open-ended loans with a revolving line of credit, the non-initial transaction pricing may be offered with improved loan pricing and terms over the original transaction loan pricing and terms. The monthly payments at the time of the non-initial transaction may be adjusted to maintain a fixed pay-down schedule. To enable this, the website or connected systems can store information related to earlier transactions or loan requests made by the same consumer, such as by storing this information in a database.

### System Implementation

Consumer loan system 10, including website 100, backend loan processing system 150 and associated rules engines and systems, may be implemented in hardware or software platforms, or a combination of both. The loan system may be implemented together on one platform, or individual elements may be implemented on separate platforms that are configured to communicate with each other over or one or more interfaces, which can also be implemented in hardware and/or software. Each platform on which loan system 10 is implemented may include one or more special purpose processors, general purpose processors, or combinations thereof, along with one or more systems for maintaining data. Such processors can execute software programs stored in computer readable media and executed by the processor. The systems for maintaining data can include one or more databases, and/or other suitable memory, including optical, magnetic, or solid state. Each processor may also communicate with the memory and interfaces to communicate with other devices. The interfaces can be used to receive both data and control information from the network as well as local sources.

### Gift Card Loan Processing and Fulfillment

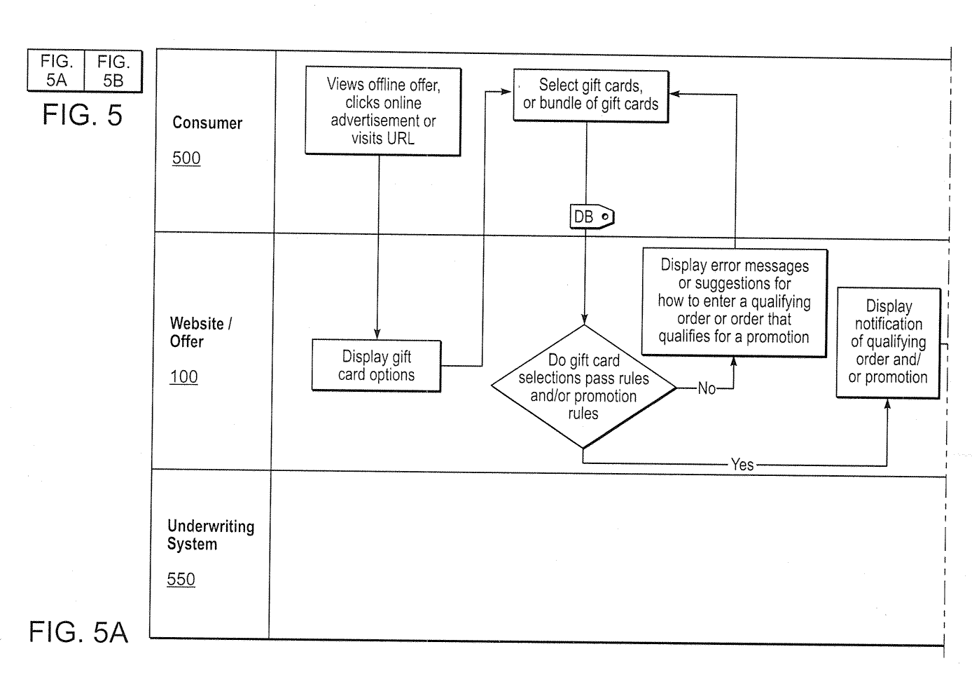

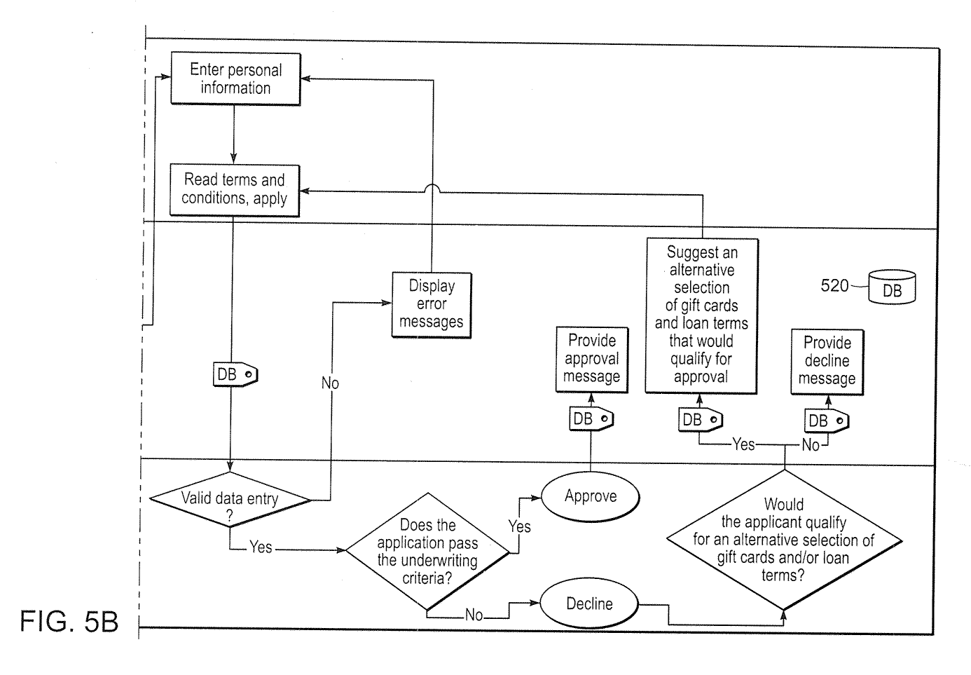

FIG. 5 illustrates a system for a consumer loan system in which a consumer 500 uses consumer-facing website 100 to apply for a loan for gift cards Website 100 interacts with a backend loan underwriting system 550. As shown in FIG. 5, the process flow begins with the consumer entering the loan website, which displays a set of gift card selections. Next, the consumer selects a set of gift cards and respective requested value amounts. The selection and/or application may be stored in database 520. As described earlier, the cards and value amounts available for selection may be determined by the brand rules and total order and card rules. The website then prompts for the consumer to provide personal information to apply for the loan, and corrections of any fields that are incorrectly filled out in the website's application page. Once all fields are correct, the gift card selection and application information is validated by the consumer, who may also be required to review various credit disclosures. The application is then sent to website 100, which passes the application to loan underwriting system 550.

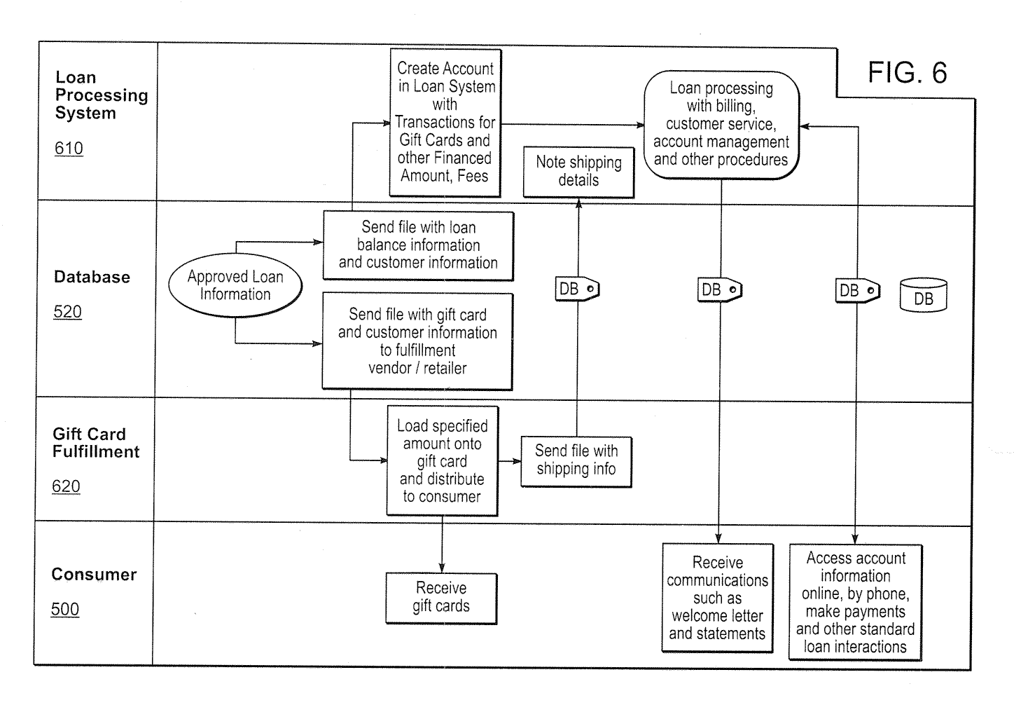

If the credit and other applicant information available to the underwriting system 550 are such that the consumer's gift card selection does not need to be modified, a credit bureau report is obtained and a final decision is made on the application based on that report and based on the gift card rules engine 160. As the application is being decisioned by the loan rules engine 160, the application may be modified so that the application has an increased chance of being approved or of qualifying for a promotion. The modifications may include lowering the gift card amounts for one or more brands, as well as changes to the terms of the proposed loan for the gift cards, such as a higher APR (annual percentage rate), a down-payment requirement, and/or annual or origination fees. The modified option is then sent to the website for the consumer to view. After approval, the loan and gift card fulfillment process (illustrated in FIG. 6) begins.

FIG. 6 illustrates a system for loan and gift card fulfillment. When a loan is approved, the final gift card selections are sent from database 520 to gift card fulfillment/provider 620. The gift card provider 620 processes the information, loads the specific amounts onto each card for the specific retailers and sends the gift cards to the consumer. The transmissions of fulfillment requests are also sent from the database 520 to the loan provisioning system 610 to notify customer service processes that the gift card distribution details have been set. Gift card provider 620 also sends information back to database 520 indicating that the cards were sent. This fulfillment information, including the distribution date for the cards, is passed to loan provisioning system 610 to enable customer service processes to track the fulfillment. Audit processes may run to produce exception reports for any problems associated with gift card fulfillment.

In addition to sending files to gift card provider 620, database 520 also creates and posts files to loan provisioning system 610, where the files contain transaction information on the loan and gift card order. In turn, the loan provisioning system posts the transaction to the consumer's account in the system, which the consumer can subsequently view through website 100 or via billing statements. The transaction is also posted to the loan provisioning system's master account file. Audit processes may run in the loan provisioning system 610 to identify any exceptions.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Other embodiments are within the following claims. For example, the described methods for providing financing for gift cards could be implemented to provide electronic gift cards directly to consumers via email, or other method, without involving a fulfillment process to send physical gift cards.

What is claimed is:

1. A method comprising:
receiving, through a user interface, a selected plurality of retailers and respective requested value amounts, wherein the selected retailers and value amounts represent a consumer's request for multiple gift cards, and wherein the gift cards provide purchasing power at the plurality of retailers in the respective value amounts, and wherein the gift cards are restricted to purchases from the plurality of retailers;
applying, through a rules engine, a set of rules to the selected retailers and value amounts, wherein the rules engine is capable of using the rules to determine costs associated with the requested gift cards;
generating a financing request for financing for the consumer, wherein the financing request is based on the selected retailers, the value amounts, and the rules;
obtaining, through a loan system interface, financing for the consumer based on the financing request; and
using the obtained financing to request the gift cards for the consumer.

2. The method of claim 1, wherein the costs associated with purchasing the gift cards can depend on which groups of retailers are selected.

3. The method of claim 2, wherein the rules are capable of indicating at least one of: limits to the proportion of a loan that may be used on a specific retailer or group of retailers, a ranking of specific retailers, discounts associated with specific retailers, exclusivity in a category for specific retailers, recommended combinations of retailers, and incentives for choosing recommended combinations.

4. The method of claim 2, further comprising using the rules to promote the sales of individual retailers.

5. The method of claim 2, further comprising:
receiving a first retailer selection and first respective requested values;
applying the rules to the selected first retailer selection and first respective requested values;
proposing, based on the rules, a suggested retailer selection or suggested respective values, where the suggested retailer selection or suggested respective values are different from the first retailer selection and first respective requested values.

6. The method of claim 2, wherein the terms of the obtained financing are further based on the selected retailers, the respective value amounts, and the rules.

7. The method of claim 2, wherein the financing includes a credit line increase to an existing loan.

8. The method of claim 2, wherein each of the gift cards can be one of a prepaid stored-value card, an e-gift card, and a gift certificate.

9. A system comprising:
an order system interface;
a loan system interface;
a rules engine;
a memory capable of storing data; and
a processor operable to communicate with the order system interface, loan system interface, and memory, the processor configured for:
receiving, through the order system interface, a selected plurality of retailers and respective requested value amounts, wherein the selected retailers and respective value amounts represent a consumer request for multiple gift cards, wherein the gift cards provide purchasing power at the plurality of retailers in the respective value amounts, and wherein the gift cards are restricted to purchases from the plurality of retailers;
applying, through the rules engine, a set of rules to the selected retailers and respective value amounts, wherein the rules engine is capable of using the rules to determine costs associated with purchasing gift cards for the selected retailers in the respective value amounts;
determining a request for financing for the consumer, wherein the request for financing is based on the selected retailers, the respective value amounts, and the rules;
obtaining, through the loan system interface, financing for the consumer based on the request for financing; and
using the obtained financing to request the gift cards for the consumer.

10. The system of claim 9, wherein the costs associated with purchasing the gift cards can depend on which groups of retailers are selected.

11. The system of claim 10, wherein the rules are capable of indicating at least one of: limits to the proportion of a loan that may be used on a specific retailer or group of retailers, a ranking of specific retailers, discounts associated with specific retailers, exclusivity in a category for specific retailers, recommended combinations of retailers, and incentives for choosing recommended combinations.

12. The system of claim 10, wherein the rules are capable of being used to promote the sales of individual retailers.

13. The system of claim 10, wherein:
the order system interface is capable of [or the processor is configured for] receiving a first retailer selection and first respective requested values;
the rules engine is capable of [or the processor is configured for] applying the rules to the selected first retailer selection and first respective requested values;
the processor is configured for proposing, based on the rules, a suggested retailer selection or suggested respective values, where the suggested retailer selection or suggested respective values are different from the first retailer selection and first respective requested values.

14. The system of claim 10, wherein the terms of the obtained financing are further based on the selected retailers, the respective value amounts, and the rules.

15. The system of claim 10, wherein the financing includes a credit line increase to an existing loan.

16. The system of claim 10, wherein each of the gift cards can be one of a prepaid stored-value card, an e-gift card, and a gift certificate.

17. Logic encoded in one or more non-transient media that includes code for execution and when executed by a processor is operable to perform operations comprising:
receiving, through a user interface, a selected plurality of retailers and respective requested value amounts, wherein the selected retailers and value amounts represent a consumer's request for multiple gift cards, and wherein the gift cards provide purchasing power at the plurality of retailers in the respective value amounts, and wherein the gift cards are restricted to purchases from the plurality of retailers;
applying, through a rules engine, a set of rules to the selected retailers and value amounts, wherein the rules engine is capable of using the rules to determine costs associated with the requested gift cards;
generating a financing request for financing for the consumer, wherein the financing request is based on the selected retailers, the value amounts, and the rules;
obtaining, through a loan system interface, financing for the consumer based on the financing request; and
using the obtained financing to request the gift cards for the consumer.

18. The logic of claim 17, wherein the determined costs associated with purchasing the gift cards can depend on which groups of retailers are selected.

19. The logic of claim 18, wherein the rules are capable of indicating at least one of: limits to the proportion of a loan that may be used on a specific retailer or group of retailers, a ranking of specific retailers, discounts associated with specific retailers, exclusivity in a category for specific retailers, recommended combinations of retailers, and incentives for choosing recommended combinations.

20. The logic of claim 18, wherein the rules can be used to promote the sales of individual retailers.

21. The logic of claim 18, wherein the code for execution is further operable to perform operations comprising:
receiving a first retailer selection and first respective requested values;
applying the rules to the selected first retailer selection and first respective requested values;
proposing, based on the rules, a suggested retailer selection or suggested respective values, where the suggested retailer selection or suggested respective values are different from the first retailer selection and first respective requested values.

22. The logic of claim 18, wherein the terms of the obtained financing are further based on the selected retailers, the respective value amounts, and the rules.

23. The logic of claim 18, wherein the financing includes a credit line increase to an existing loan.

24. The logic of claim 18, wherein each of the gift cards can be one of a prepaid stored-value card, an e-gift card, and a gift certificate.
